(19) United States
(12) Patent Application Publication
(10) Pub. No.: US 2011/0038029 A1
(43) Pub. Date: Feb. 17, 2011

(54) DISPLAY LIQUID FOR ELECTROPHORETIC DISPLAY DEVICE, DISPLAY PANEL AND ELECTROPHORETIC DISPLAY DEVICE

(75) Inventor: Yumiko OSHIKA, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/869,637

(22) Filed: Aug. 26, 2010

Related U.S. Application Data
(63) Continuation-in-part of application No. PCT/JP2009/051471, filed on Jan. 29, 2009.

(30) Foreign Application Priority Data
Feb. 26, 2008 (JP) 2008-044575

(51) Int. Cl. G02F 1/167; H01B 1/12

(52) U.S. Cl. 359/296; 252/500

(57) ABSTRACT

A display liquid which is used in a display panel for an electrophoretic type display device is produced by adding a second solvent comprising any one of alcohols, aldehydes, or ketones of carbon numbers 6 to 8 to a hydrocarbon-based first solvent.

### TECHNICAL FIELD

The present invention relates to a display liquid for an electrophoretic display device which can change a visual recognition state reversibly with the action of an electric field, and a display panel and an image display device which are provided with the display liquid.

### BACKGROUND ART

There is known an electrophoretic display device provided with a display panel used in place of printed sheets used for a book or a magazine. As an example, in a display panel for an electrophoretic display device, a transparent substrate to be a display surface, and a substrate on which an image is to be formed are placed opposite each other at a desired interval therebetween via a spacer, and partitions forming spaces which can be sealed between the substrates in a matrix form in accordance with display pixels. The space for each pixel is filled up with a display liquid that contains a solvent containing a first colored particle which contains a first coloring component (for example, black) and is electrically charged to one polarity, and a second colored particle which contains a second coloring component (for example, white) different from the first coloring component and is electrically charged to the opposite polarity.

Each substrate is provided with an electrode which can generate an electric field reversibly in accordance with the space for each pixel. The display panel displays an arbitrary image depending on whether the first colored particle or the second colored particle is drawn toward the transparent substrate with an electric field applied to the space for each pixel. There is also known a device which forms a display panel by coloring a solvent to a color different from that of the first colored particle, without using the second colored particle, and causing the first colored particle to be drawn toward the transparent substrate side or to be moved away from the transparent substrate side.

Such a display panel for an electrophoretic display device is required to have high contrast. However, there was a case where it would be difficult to maintain the display stably due to occurrence of the coagulation or the like originated from the electric attraction between particles when the display liquid was used repeatedly, which would cause the coagulation-oriented color mixing, degrading the contrast as a result. As a solution to this problem, there is a proposal such that a polymer type surfactant or the like is contained in the main solvent (first solvent) as a second solvent (disperser) and forming an adsorption layer on the surfaces of the colored particles.

However, the method of letting the display liquid contain the disperser, such as the aforementioned surfactant, could not sufficiently ensure the stable maintenance of the state where the colored particles are dispersed in the solvent, so that the colored particles are mal-distributed, thereby degrading the display quality due to reduction of contrast.

### DISCLOSURE OF THE INVENTION

Accordingly, it is an object of the present invention to provide a disperser which can improve dispersion of colored particles in a solvent and can increase the response speed in order to solve the above mentioned problem.

To solve the problem, an embodiment of a display liquid for an electrophoretic type display device according to the invention is a display liquid for an electrophoretic type display device, in which a second solvent comprising any one of alcohols, aldehydes, or ketones of carbon numbers 6 to 8 is added to a hydrocarbon-based first solvent.

### BRIEF DESCRIPTION OF THE DRAWINGS

FIG. 1 is a block diagram showing the schematic configuration of an electrophoretic display device according to one embodiment of the invention.

FIG. 2 is a block diagram showing the schematic configuration of a display panel 11.

### DETAILED DESCRIPTION OF THE INVENTION

### General Description

To solve the problem, according to an embodiment of a display liquid for an electrophoretic type display device as set forth in claim 1 of the invention, a display liquid for an electrophoretic type display device has a hydrocarbon-based first solvent to which a second solvent comprising any one of alcohols, aldehydes, or ketones of carbon numbers 6 to 8 is added.

The embodiment is applicable to a display liquid which has a dispersion liquid (second solvent) added to a solvent (first solvent) for a display panel for an electrophoretic type display. The hydrocarbon-based first solvent may be, for example, isoparaffin-based hydrocarbon which has electric insulation.

Alcohols of carbon numbers 6 to 8 are compounds which have a hydroxyl group (—OH) bound to skeleton compounds of carbon numbers 6 to 8. For example, alcohol is hexanol when it has a hexane skeleton of acyclic hydrocarbon of carbon number 6. In case of carbon number 7, it is heptanol which has a heptane skeleton, and in case of carbon number 8, it is octanol which has an octane skeleton.

Aldehydes of carbon numbers 6 to 8 are compounds which have an aldehyde group (HCO—: formyl group) bound to skeleton compounds of carbon numbers 6 to 8. For example, aldehyde is hexanal when it has a hexane skeleton of acyclic hydrocarbon of carbon number 6. In case of carbon number 7, it is heptanal which has a heptane skeleton, and in case of carbon number 8, it is octanal which has an octane skeleton.

Ketones of carbon numbers 6 to 8 are compounds which have a carbonyl group (—CO—) bound to skeleton compounds of carbon numbers 6 to 8. For example, ketone is hexanone when it has a hexane skeleton of acyclic hydrocarbon of carbon number 6. In case of carbon number 7, it is heptanone which has a heptane skeleton, and in case of carbon number 8, it is octanone which has an octane skeleton.

When alcohols or the like of carbon numbers 6 to 8 are added to the hydrocarbon-based first solvent, colored particles can be moved fast since alcohols or the like have carbon numbers of 6 to 8 and comparatively low viscosity. According to the embodiment, therefore, even if power supplied to the electrodes of the display panel has a short pulse width of 50 mS or so, the colored particles can be drawn toward the display panel, or can be moved away from the display panel within the supply time. Since increasing the migration speed of colored particles suppresses coagulation of the colored particle in the solvent to make it possible to stably maintain dispersion, a reduction of contras can be suppressed.

Contrast is the difference between the brightness of a bright portion and that of a dark portion when the screen is displayed; the greater the difference, the higher the contrast. To increase the contrast, on the other hand, a bright (whitish) portion is made brighter (more whitish), or a dark (blackish) portion is made darker (more blackish), or both are carried out simultaneously.

If a time period that display is kept stable even without applying a voltage to the electrodes, the amount of power supply can be reduced, thereby lowering power consumption. If the individual colored particles are uniformly dispersed over the whole screen to achieve high display uniformity, mal-distribution of the colored particles is eliminated, thereby reducing display failures of generating a portion where a character becomes deeper partially, and a portion where a character becomes lighter on the contrary.

Preferably, as in the subject matter according to claim 2, the mixture ratio (weight ratio) of the first solvent and the second solvent may range from 2:1 to 7:1. The mixture ratio (weight ratio) of the first solvent and the second solvent being 2:1 means that 160 g of the first solvent and 80 g of the second solvent are mixed when the gross weight of the final solvent is 240 g. Likewise, the mixture ratio (weight ratio) of the first solvent and the second solvent being 7:1 means that 210 g of the first solvent and 30 g of the second solvent are mixed when the gross weight of the final solvent is 240 g. When the gross weight of the final solvent is 240 g, the first solvent can have a weight between 160 g to 210 g, and the second solvent can have a weight of 80 g to 30 g which is the remainder resulting from the deduction of the weight of the first solvent.

With the mixture ratio of the first solvent and the second solvent being set within the above limit, the electric insulation of the first solvent can be maintained even if an alcohol or the like which is not insulative is added as the second solvent. Therefore, since the final solvent is insulative according to the embodiment, colored particles can be charged.

It is more preferable that as in the subject matter according to claim 3, the second solvent comprises aldehyde of carbon number 6, and the mixture ratio (weight ratio) of the first solvent and the second solvent ranges from 2:1 to 5:1.

With the mixture ratio of the first solvent and the second solvent being set within the above limit, a colored particle can be moved faster. According to the embodiment, therefore, even if power supply to the electrodes of the display panel is carried out with a short pulse width of 50 mS or the like, colored particles can be drawn toward the display panel to the saturation state or can be moved away therefrom to the saturation state within the supply time. Since coagulation of the colored particles in the solvent can be further suppressed to stably keep the dispersion by making the migration speed of the colored particles faster, it is possible to further suppress a reduction of contrast.

To solve the aforementioned problem, according to an embodiment of the display panel according to claim 4 of the invention, the display device has the display liquid for an electrophoretic type display device as recited in any one of the foregoing subject matters. The embodiment can provide an electrophoretic type display panel which has an improvement made on a reduction in contrast.

To solve the aforementioned problem, an embodiment of an electrophoretic type display according to claim 5 of the invention is equipped with the display panel according to claim 4. The embodiment can provide an electrophoretic type image display device which suppresses a reduction of contrast.

### EFFECT OF THE INVENTION

As mentioned above, since the display liquid for an electrophoretic type display device according to the invention can suppress coagulation of the colored particles in the solvent to stably keep the dispersion by making the migration speed of the colored particles faster, a reduction of the contrast of the display panel and the display device can be suppressed, thereby enhancing the uniformity of the screen to reduce display failures.

### DESCRIPTION OF ILLUSTRATED EMBODIMENT

Hereinafter, an embodiment of a display liquid for an electrophoretic type display device of the invention and an embodiment of an image display device in which a display panel using the display liquid is mounted will be described below in detail referring to the drawings.

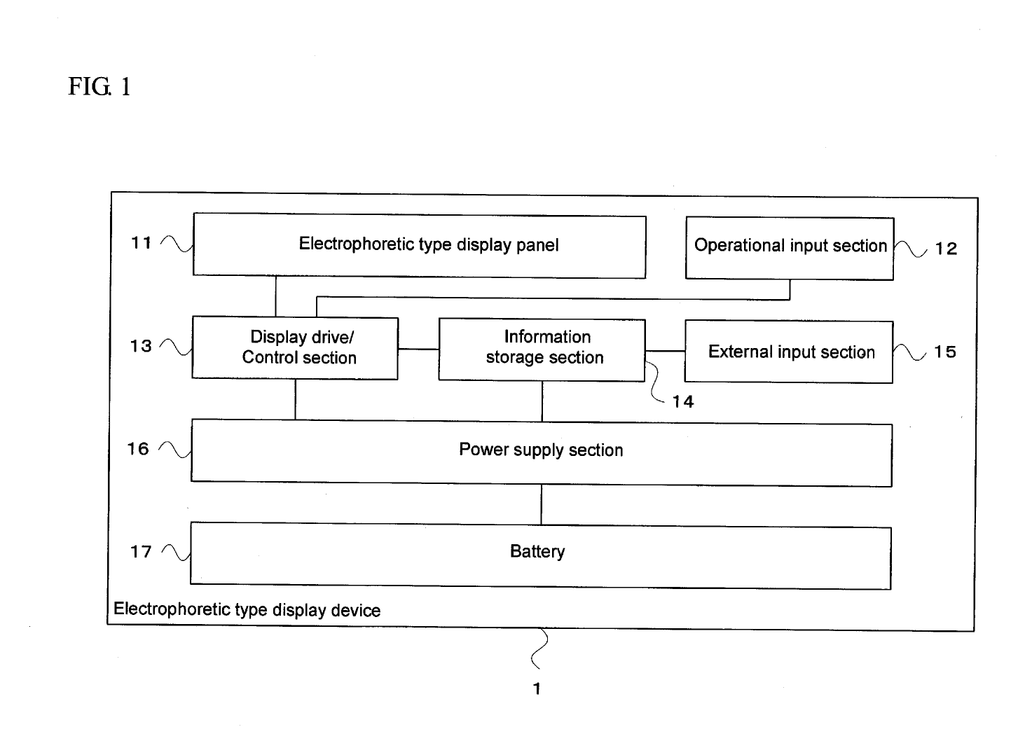

FIG. 1 is a block diagram showing the schematic configuration of an electrophoretic display device according to one embodiment of the invention.

An electrophoretic display device 1 (image display device) has an electrophoretic type display panel 11 (which will hereinafter be also referred to as display panel 11) which displays a character or an image on the surface by displaying a first display color (for example, white) or a second display color (for example, black) for every plurality of pixels blocks aligned in a matrix form, an operation input section 12 which receives an input made by a user with a keypad, a touch panel or the like, and a display drive/control section 13 which generates an electric field for each pixel of the display panel 11 to display an image or the like thereon.

The electrophoretic display device 1 further has an information recording section 14 which stores data such as an image to be displayed on the display panel 11, and operation system/image display software or the like, an external input section 15 which can input data such as an image into the information recording section 14, a power supply section 16 which supplies adequate voltages to the display drive/control section 13, the information recording section 14, etc., and a battery 17 which supplies power to the power supply section 16. The data such as an image to be stored in the information recording section 14 may be input by mounting a detachable storage device or the like, or power may be supplied from a commercially available power supply in place of the battery 17.

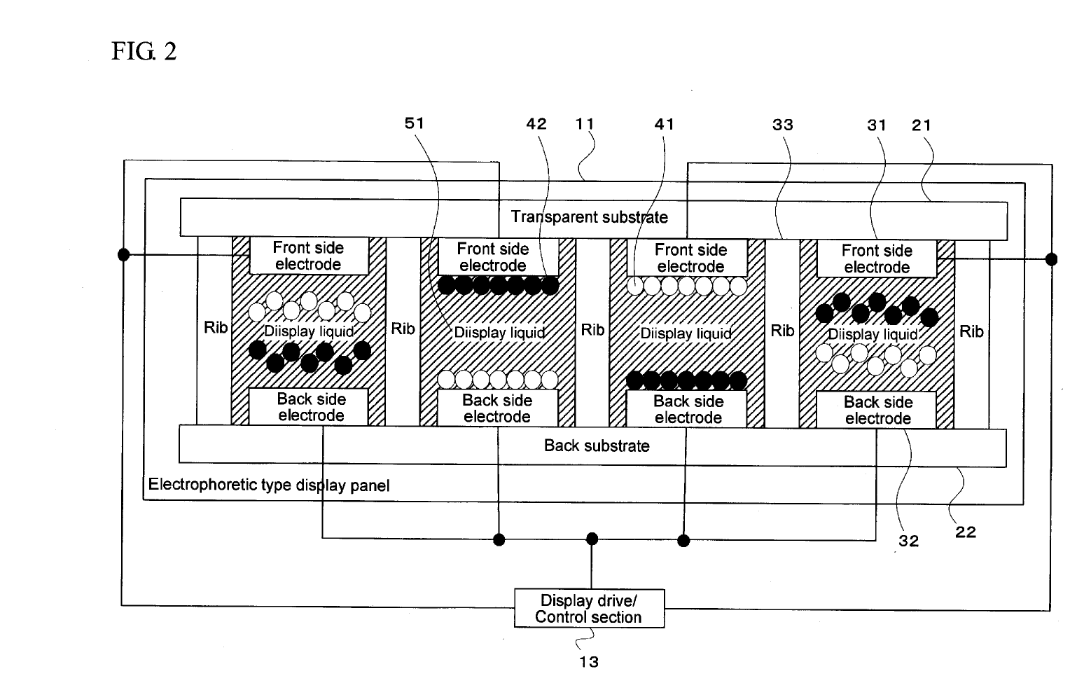

FIG. 2 is a block diagram showing the schematic configuration of the display panel 11.

The display panel 11 has a transparent substrate 21 which is formed of a material to pass visible light and is arranged on the front side of the display panel 11, so that the user can see an image according to the color difference for each pixel block, a back substrate 22 arranged on the back side of the display panel 11, a front side electrode 31 provided inward (on the back side) of the transparent substrate 21, a back side electrode 32 provided inward (on the front side) of the back substrate 22, and wall-like ribs 33 which separate individual adjoining pixel blocks.

The space surrounded by the inner side of the transparent substrate 21, the inner side of the back substrate 22, and the inner wall of the rib 33 is formed for each pixel block. The front side electrode 31 is arranged on the front side of the space of each pixel block in contact with the inner side of the transparent substrate 21, and the back side electrode 32 is arranged on the back side of the space of each pixel block in contact with the inner side of the back substrate 22. Either a positive or negative voltage is individually supplied to the individual electrodes 31, 32 by the display drive/control section 13. At least the front side electrode 31 provided at the transparent substrate 21 is formed of the material for a transparent electrode (indium tin oxide: ITO or the like).

The space of each pixel block is filled up with a display liquid 51. The display liquid 51 has an isoparaffin-based hydrocarbon which has electric insulation as a first solvent, and colored particles 41 of polymethylmethacrylate (PMMA: polymethylmethacrylate, acrylic resin) containing a white titanium oxide, colored particles 42 of PMMA containing a black carbon black, and a second solvent as a disperser are added therein. As the individual colored particles 41, 42, silicon dioxide (silica) provided on the surfaces or near the surfaces of the colored particles may be used.

### <Examinations on Solvents Suitable as a Disperser>

First, examinations were made on what kind of medium is suitable as the second solvent that is a disperser. Plural kinds of display liquids 51 having the white colored particle 41, the black colored particles 42, and the second solvent added therein were prepared, and examined. As the second solvent, hexanol (alcohol), hexanal (aldehyde), and hexanone (ketone) of carbon number 6 were used, and the mixture ratio (weight ratio) of the first solvent to the second solvent was set to 2.3:1. For the purpose of comparison, examinations have been made on the cases where methyl hexanoate, hexylbenzene, a nonionic surfactant A and a nonionic surfactant B whose hydrophilic portions were nonionic, an anionic surfactant A whose hydrophilic portion would become negative ions when dissociated in water, and a cationic surfactant A whose hydrophilic portion would become positive ions were used as the second solvent under the same conditions.

The transparent substrate 21 and the back substrate 22 were arranged so that the front side electrode 31 and the back side electrode 32 might face each other at an interval of 30 μm, and the display liquid was injected between the individual substrates. With the display drive/control section 13 connected to each electrode, the luminance in case where all the pixels would display white, and the luminance in case where all the pixels would display black were measured by luminance meter BM-7 produced by TOPCON CORP. The ratio of the luminance in white display to the luminance in black display was acquired as contrast. Since the contrast of the white portion of space of a piece of newspaper and the black portion of the printed part (black ink part) was 8:1, such ration was used as a reference. Judgment on usability was made based on the condition that the contrast would be usable if it was equal to or higher than the reference but would not be usable if it was less than the reference.

TABLE 1

| solvent 2 (disperser) | white:black contrast | decision |
|---|---|---|
| hexanol | 8:1 | ◯ |
| hexanal | 14:1 | ◯ |
| hexanone | 12:1 | ◯ |
| methyl hexanoate | 4:1 | X |
| hexylbenzene | 5:1 | X |
| nonionic surfactant A | 4:1 | X |
| nonionic surfactant B | 4:1 | X |
| anionic surfactant A | 4:1 | X |
| cationic surfactant A | 6:1 | X |

Decision
◯: white/black contrast of 8:1 or higher
X: white/black contrast of less than 8:1

Results of the measurement and decision shown in Table 1 show that in cases where hexanol, hexanal, and hexanone of carbon number 6 were used as the second solvent, when the mixture ratio (weight ratio) of the first solvent to the second solvent was set to 2.5:1, the contrast became 8:1 or higher, and the decision resulted in usable (O) in every case. In cases where methyl hexanoate, hexylbenzene, a nonionic surfactant A, a nonionic surfactant B, an anionic surfactant A, and a cationic surfactant A were used as the second solvent, by way of contrast, the contrast became less than 8:1, and the decision resulted in unusable (X) in every case under the same conditions.

It is apparent from the above measurement results that when at least hexanol, hexanal, and hexanone of carbon number 6 are used as the second solvent and the mixture ratio (weight ratio) of the first solvent to the second solvent is set to 2.5:1, a better contrast is acquired as compared with the case of using a surfactant. In addition, hexanal (aldehyde) provides the highest contrast (14:1), hexanone (ketone) provides the next highest contrast (12:1), and hexanol (alcohol) provides the next highest contrast (8:1). It is to be noted that even if the carbon number is 6, the hexylbenzene of cyclic hydrocarbon cannot improve the contrast. Even in case of acyclic hydrocarbon of carbon number 6, methyl hexanoate (ester) or the like cannot improve the contrast.

### <Examinations on the Ratio of Adding the Disperser to the First Solvent>

Next, examinations were made on the adequate ratio of the second solvent as a disperser to be added to the first solvent. In consideration of the examination results on the solvents suitable as a disperser, plural kinds of display liquids 51 in which only hexanol, hexanal and hexanone were added as the second solvent to the first solvent in variable ratios, and the contrasts were examined. The method of measuring the contrast and the method for making decision were the same as those in the examinations on solvents suitable as a disperser.

TABLE 2

| | white:black contrast = decision | | | | |
|---|---|---|---|---|---|
| | solvennt | solvennt | solvennt | solvennt | solvennt |
| solvent 2 | 1:solvent | 1:solvent | 1:solvent | 1:solvent | 1:solvent |
| (disperser) | 2 = 1.6:1 | 2 = 2.3:1 | 2 = 2.5:1 | 2 = 6.3:1 | 2 = 32:1 |
| hexanol | 1:1 = X | 8:1 = ◯ | 8:1 = ◯ | 8:1 = ◯ | 3:1 = X |
| hexanal | 1:1 = X | 10:1 = ◯ | 14:1 = ◯ | 10:1 = ◯ | 3:1 = X |
| hexanone | 1:1 = X | 10:1 = ◯ | 12:1 = ◯ | 10:1 = ◯ | 3:1 = X |

Decision
◯: white/black contrast of 8:1 or higher
X: white/black contrast of less than 8:1

According to results of the measurement and decision shown in Table 2 show that when the mixture ratio (weight ratio) of the first solvent to the second solvent was set to 1.6:1, the contrast became 1:1 (less than 8:1), and the decision resulted in unusable (X) for every second solvent. When the mixture ratio (weight ratio) was set to 2.3:1, by way of contrast, the contrast became 8:1 or higher, and the decision resulted in usable (O) for every second solvent. Likewise, when the mixture ratio (weight ratio) was set to 2.5:1 and 6.3:1, the contrast became 8:1 or higher, and the decision resulted in usable (O) for every second solvent. When the mixture ratio (weight ratio) was set to 32:1, however, the contrast became 3:1 (less than 8:1), and the decision resulted in unusable (X) for every second solvent.

In consideration of the above measurement results, the mixture ratio (weight ratio) of the first solvent to the second solvent has one usable/unusable boundary between 1.6:1 and 2.3:1, and has another usable/unusable boundary between 6.3:1 and 32:1. Therefore, roughly speaking, a good contrast is acquired if the mixture ratio (weight ratio) of the first solvent to said second solvent lies within the range of 2:1 to 7:1. When the mixture ratio (weight ratio) is set to 2.5:1, the contrast is the best among the measured contrasts (14:1 for hexanal, 12:1 for hexanone), and when the mixture ratio (weight ratio) is set to 2.3:1 and 6.3:1, the contrast becomes lower a little (10:1 for hexanal, 10:1 for hexanone). In view of the above, the mixture ratio (weight ratio) with the best contrast is in the neighborhood of 2.0:1 to 2.5:1.

<Examinations on Dispersers Other than Those of Carbon Number 6>

Next, examinations were also made on whether the foregoing examinations results can be applied to cases where alcohols, aldehydes, and ketones of carbon numbers other than carbon number 6 are used as the second solvent or the disperser. As the second solvent, alcohols of carbon numbers 2, 4, 10, and 12 in addition to hexanol of carbon number 6, aldehydes of carbon numbers 8 and 12 in addition to hexanal of carbon number 6, and ketone of carbon number 8 in addition to hexanone of carbon number 6 were used. With the mixture ratio (weight ratio) of the first solvent to the second solvent set to 2.5:1, plural kinds of display liquids 51 having the second solvents with different carbon numbers respectively added thereto were prepared, and the contrasts were examined. The method of measuring the contrast and the method for making decision were the same as those in the examinations on solvents suitable as a disperser.

TABLE 3

| | white:black contrast = decision | | | | | |
|---|---|---|---|---|---|---|
| | | | | | carbon | carbon |
| solvent 2 | carbon | carbon | carbon | carbon | number = | number = |
| (disperser) | number = 2 | number = 4 | number = 6 | number = 8 | 10 | 12 |
| alcohols | 2:1 = X | 2:1 = X | 8:1 = ◯ | 8:1 = ◯ | 3:1 = X | 3:1 = X |
| aldehydes | — | — | 14:1 = ◯ | 8:1 = ◯ | — | 5:1 = X |
| ketone | — | — | 12:1 = ◯ | 8:1 = ◯ | — | — |

Decision
◯: white/black contrast of 8:1 or higher
X: white/black contrast of less than 8:1
—: unmeasured (deleterious substance or the like)

The measurement results and decision results shown in Table 3 show that for alcohols (ethanol and butanol) of carbon numbers 2 and 4, the contrast became 2:1 (less than 8:1), and the decision resulted in unusable (X). For hexanol, hexanal, and hexanone of carbon number 6, as apparent from the examinations on the solvents suitable as a disperser and the examinations on the ratios of the disperser to be added to the first solvent, the contrast became 8:1 or higher, and the decision resulted in usable (O). With regard to octanol, octanal, and octanone of carbon number 8, the contrast also became 8:1 or higher, and the decision resulted in usable (O). For decanol of carbon number 10, the contrast was 3:1 (less than 8:1), and the decision resulted in unusable (X). For dodecanol of carbon number 12, the contrast was 3:1 (less than 8:1), and the decision resulted in unusable (X), and for dodecanal, the contrast was 5:1 (less than 8:1), and the decision resulted in unusable (X).

In view of the above measurement results, it is only alcohols, aldehyde, and ketone of carbon number 6 and carbon number 8 that can be used as the second solvent or the disperser, and aldehyde and ketone of carbon number 6 provide better contrast than aldehyde and ketone of carbon number 8. Alcohols, aldehydes, and ketones of carbon numbers equal to or less than 4 and equal to or greater than 10, when used as the second solvent, would worsen the contrast.

From the above measurement results, when alcohols, aldehydes, and ketones of carbon numbers 6 to 8 are added as the second solvent to the hydrocarbon-based first solvent, the second solvents have carbon numbers 6 to 8 and comparatively low viscosity, so that colored particles can be moved fast, thereby improving the contrast, but if the amount of additive is too large or too small, the contrast is reduced. From the above examinations, when hexanal which is an aldehyde of carbon number 6 is used as the second solvent, and the mixture ratio (weight ratio) of the first solvent to the second solvent is set to 2.5:1, the best contrast can be acquired. In addition, it is alcohols, aldehydes, and ketones of carbon numbers 6 and 8 that provide the effect as the second solvent, and when the mixture ratio (weight ratio) of the first solvent to the second solvent is set in the range of 2:1 to 7:1.

As apparent from the above, since the display liquid for an electrophoretic type display device according to the embodiment can suppress coagulation of the colored particles in the solvent to stably keep the dispersion by making the migration speed of the colored particles faster, a reduction of contrast can be suppressed. Further, the use of the display liquid according to the embodiment in an electrophoretic type display device can reduce the amount of power supplied thereto, thereby reducing power consumption and extending the time period of using the battery at outdoor or the like. This makes it possible to enhance the uniformity of the screen to reduce display failures.

The technical scope of the invention, which has been described referring to the embodiment by way of example, is not limited to the description of the embodiment. Hydrocarbons other than an isoparaffin-based hydrocarbon may be used as the first solvent, and the first solvent may contain only one type of colored particles and may be applied to a display panel which provides display with the display liquid colored with another color. Although the foregoing description of the embodiment of the invention has been given of the display panel which displays characters or images with a plurality of pixel blocks separated in a matrix form by partitions, the invention is not limited to this display panel, but may be adapted to a display panel which does not have partitions for pixel blocks.

### DESCRIPTION OF REFERENCE NUMERALS

1 Electrophoretic type display
11 Electrophoretic type display panel
12 Operation input section
13 Display drive/control section
14 Information recording section
15 External input section
16 Power supply section
17 Battery
21 Transparent substrate
22 Back substrate
31 Front side electrode
32 Back side electrode
33 Ribs
41 Coloring particles (white)
42 Coloring particles (black)
51 Display liquid.

1. A display liquid for an electrophoretic type display device, wherein a second solvent comprising any one of alcohols, aldehydes, or ketones of carbon numbers 6 to 8 is added to a hydrocarbon-based first solvent.

2. The display liquid according to claim 1, wherein a mixture ratio (weight ratio) of the first solvent and the second solvent ranges from 2:1 to 7:1.

3. The display liquid according to claim 2, wherein the second solvent comprises aldehyde of carbon number 6, and
the mixture ratio (weight ratio) of the first solvent and the second solvent ranges from 2:1 to 5:1.

4. A display panel having the display liquid for an electrophoretic type display device as recited in claim 1.

5. An electrophoretic type display device equipped with the display panel according to claim 4.

6. A display panel having the display liquid for an electrophoretic type display device as recited in claim 2.

7. A display panel having the display liquid for an electrophoretic type display device as recited in claim 3.

8. An electrophoretic type display device equipped with the display panel according to claim 6.

9. An electrophoretic type display device equipped with the display panel according to claim 7.
